(19) United States
(12) Patent Application Publication
(10) Pub. No.: US 2021/0234353 A1
(43) Pub. Date: Jul. 29, 2021

(54) SEALING DEVICE

(71) Applicant: Reichle & De-Massari AG, Wetzikon (CH)

(72) Inventor: Maurizio DI DOMENICO, Brüttisellen (CH)

(21) Appl. No.: 15/734,598

(22) PCT Filed: Dec. 20, 2018
(86) PCT No.: PCT/EP2018/086221

§ 371 Date: Dec. 3, 2020

(30) Foreign Application Priority Data
Jun. 4, 2018 (DE) 10 2018 113 247.6

(51) Int. Cl. H02G 15/013; H02G 3/08; H02G 3/22

(52) U.S. Cl. CPC H02G 15/013; H02G 3/22; H02G 3/085

(57) ABSTRACT

A sealing device for a pass-through and sealing of an elongate object has at least one sealing unit which is configured, in a mounted state, to encompass the object at least section-wise completely in a circumferential direction, and which comprises at least one sealing section that is configured, in the mounted state, to contact the object and to seal it by means of intrinsic pre-tension, the sealing section is implemented at least partially of a colloid-like material.

### STATE OF THE ART

The invention concerns a sealing device according to the preamble of claim 1 and a method for a sealing of at least one elongate object with respect to a sealing panel according to the preamble of claim 15.

A sealing device with a sealing unit comprising a sealing element with step-wise offset regions having different diameters and comprising a through-hole for a pass-through of a cable is already known from the European patent document EP 2 764 591 B1. To achieve a sealing effect in a pass-through of the cable, regions having a diameter smaller than the diameter of the cable are separated off. The sealing unit is implemented of a thermoplastic synthetic material, like styrene-ethylene-butylene-styrene (SEBS), or of an elastomer, like for example nitrile butadiene caoutchouc. The sealing unit is fixated with its base body via press-fitting on a frame element consisting of two frame portions.

The objective of the invention is in particular to provide a generic sealing device having improved characteristics regarding assembly. The objective is achieved according to the invention by the features of claims 1 to 15 while advantageous implementations and further developments of the invention may be gathered from the dependent claims.

### Advantages of the Invention

The invention is based on a sealing device for a pass-through and sealing of an elongate object, with at least one sealing unit which is configured, in a mounted state, to encompass the object at least section-wise completely in a circumferential direction, and which comprises at least one sealing section that is configured, in the mounted state, to contact the object and to seal it by means of intrinsic pre-tension.

It is proposed that the sealing section is implemented at least partially, preferably completely, of a colloid-like material.

This advantageously enables simplifying assembly. It is advantageously possible to facilitate a time-saving assembly procedure. In particular, a cost-efficient implementation is achievable. It is in particular possible to achieve a simplification of assembly by way of an advantageous construction.

A “sealing device” is in particular to mean a portion of a sealing system, in particular of a cable sleeve, which is in particular configured to protect cable contact points from environment impact. The sealing system preferably comprises the sealing device and at least one enclosure, especially preferentially a dome closure, with a sealing panel, in particular a sleeve bottom, which the sealing device is arrangeable on. In particular, the sealing device may be configured for a pass-through and sealing of more than only one elongate object, in particular of at least two elongate objects.

By an “elongate object” is in particular an object to be understood which has in at least one developed state an expansion along a main extension direction that is at least twice as large, advantageously at least three times, preferably at least five times as large as the diameter of the object, which is in particular measured transversely to the main extension direction. In particular, the elongate object may be implemented as a tube, in particular a blow-in tube, and/or preferably as a cable, in particular as an electrical cable and/or especially advantageously as a waveguide cable. A “main extension direction” of an object is here in particular to mean a direction extending parallel to a longest edge of a smallest imaginary rectangular cuboid which just still completely encloses the object.

By a “sealing unit” is in particular a unit to be understood which at least substantially completely prevents a penetration of matter from a first region into a second region and vice versa, and/or an exchange of matter of the first region and the second region, between which the sealing unit is arranged at least partly. In particular, the sealing unit has a protective effect against an entry of humidity and/or liquid. By “at least substantially completely” is here in particular to be understood that a penetration of matter from the first space into the second space and vice versa is below a leakage rate that is suitable for the intended application purpose and is in particular defined by law and/or by standards.

The sealing unit in particular comprises at least one, preferably precisely one, pass-through channel for the object. The sealing unit may advantageously comprise two, three or in particular a plurality of pass-through channels, each for one object. The pass-through channel is in particular configured for receiving the object. In particular, viewed over its length, the pass-through channel has a variable pass-through channel diameter. In particular, the pass-through channel has a length that is at least as large, in particular at least twice as large, advantageously at least three times as large as the maximum pass-through channel diameter. In particular, the pass-through channel has a length of at least 20 mm, advantageously at least 30 mm and preferably at least 35 mm. In particular, the maximum pass-through channel diameter is at least 5 mm, advantageously at least 8 mm and especially advantageously at least 10 mm. In particular, viewed over a length of the sealing unit, a diameter of the sealing unit has a variable size. In particular, a maximum diameter of the sealing unit is at least equal to the maximum pass-through channel diameter, preferably at least equal to 1.5 times the maximum pass-through channel diameter and/or preferentially at least equal to 1.9 times the maximum pass-through channel diameter. In particular, the maximum diameter of the sealing unit has a value between 18 mm and 22 mm.

A “sealing section” is in particular to mean a portion of the sealing unit which is in a mounted state configured to implement a sealing effect. The sealing section is in particular hollow-cylinder-shaped with an inner and an outer diameter and with an outer and an inner surface. In particular, the pass-through channel for the object extends at least partly through the sealing section. In particular, the sealing section seals the object off inside the pass-through channel at least in a longitudinal direction. By a “mounted state” is in particular a state of a unit to be understood in which individual components of the unit are composed and/or mutually connected in such a way that the unit is capable of fulfilling and/or executing at least one function assigned to the unit and is at the same time capable of exerting an effect assigned to the unit onto a further unit, wherein in particular the unit contacts the further unit. In particular, the sealing unit applies in the mounted state a sealing effect to the object, the object being inserted in the sealing unit.

By a “colloid-like material” is in particular a material to be understood which has at least one solid and at least one liquid and/or gaseous component. In particular, the solid component is realized as a sponge-like three-dimensional matrix in which the liquid and/or gaseous component is distributed. The colloid-like material is preferentially implemented at least partly and preferably completely as a gel, preferentially as a polyurethane gel. In particular, the colloid-like material is dimensionally stable under standard conditions, wherein under a small, in particular mechanical, load the material at least undergoes a reversible shape change and then, under absence of the load, re-assumes its original shape. In particular, the material has elastic properties. Advantageously the colloid-like material is in particular reversibly deformable, wherein it assumes a shape it had prior to the deformation. In particular, the colloid-like material is capable of changing its extension in particular in a plurality of dimensions wherein, for example, a change in the length of the shape of the colloid-like material is accompanied by a change in the width of the shape of the colloid-like material.

An “intrinsic pre-tension” is in particular to mean a characteristic of a unit in which, when contacting a further unit that is to be sealed, the unit exerts a self-sealing function without requiring assistance from other units.

“Configured” is in particular to mean specifically programmed, designed and/or equipped. By an object being configured for a certain function is in particular to be understood that the object fulfills and/or executes said certain function in at least one application state and/or operation state.

It is further proposed that the sealing unit comprises at least one further sealing section, which is configured, in the mounted state, to contact and to seal by intrinsic pre-tension at least one further elongate object that differs from the elongate object. As a result it is in particular possible for a sealing of a plurality of elongate objects to be advantageously effected independently from one another. It is conceivable that the sealing unit comprises a plurality of further sealing sections passing through and sealing one elongate object respectively. In particular, the sealing section and the further sealing section/sections are arranged side by side. Advantageously the sealing section and the further sealing section/sections are implemented identically and advantageously have identical characteristics. Alternatively the sealing section and the further sealing section/sections could be implemented differently. In particular, the further sealing section is implemented at least partially and preferably completely of a colloid-like material.

Furthermore it is proposed that in at least one demounted state the sealing section and/or the further sealing section have/has an at least substantially constant inner diameter at least over a large portion of its/their length. This in particular enables an adaption to the inserted elongate object, optimized over an entire length of the sealing section and/or of the further sealing section. In particular, in a state when the sealing unit is mounted on the elongate object, the sealing section and/or the further sealing section are/is tightly adjacent to the elongate object over their/its entire length. In particular, the sealing section and/or the further sealing section exert/exerts in the mounted state a radially inwards-directed pressure onto the elongate object. Advantageously in the mounted state the pressure is continuously applied over the entire length of the sealing section and/or of the further sealing section.

By a “demounted state” is in particular a state of a unit to be understood in which the unit has no effect and/or no function, in particular with respect to a further unit, and/or the unit and the further unit have no contact.

It is moreover proposed that in at least one demounted state the sealing section and/or the further sealing section have/has an at least substantially constant outer diameter respectively at least over a large portion of their/its length. This in particular allows achieving an even sealing effect onto the elongate object in the mounted state, preferentially in each contact point between the sealing section and/or the further sealing section and the elongate object in the mounted state. In particular, the outer diameter of the sealing section and/or of the further sealing section is greater than the length of the sealing section and/or of the further sealing section.

Beyond this it is proposed that the sealing unit comprises at least one cable insertion section for an insertion of the object. Alternatively it is possible that the sealing unit comprises advantageously two, in particular a plurality of, cable insertion sections, each for the insertion of an object. In this way it is in particular possible to provide an insertion aid for a technician during assembly, as a result of which time-saving is achievable. In particular, this advantageously allows augmenting process reliability in assembly. In particular, the cable insertion section/sections and the sealing section and/or the further sealing section are integrally connected with one another. “Integrally” is in particular to mean at least by substance-to-substance bond, for example by a welding process, a gluing process, an injection-molding process and/or another process deemed expedient by someone skilled in the art, and/or advantageously formed in one piece, like for example by production from a cast and/or by production in a one-component and/or multi-component injection-molding process and/or by production in a printing process, and advantageously from a single blank. The cable insertion section/sections is/are in particular implemented as a hollow body/hollow bodies. In particular, the cable insertion section/sections has/have along its/their respective main extension direction different outer and/or inner diameters. In particular, the cable insertion section/sections on average respectively has/have an outer and/or inner diameter that is greater than an outer and/or inner diameter of the sealing section and/or the further sealing sections. In particular, the cable insertion section/sections respectively has/have a greater inner diameter in comparison to a diameter of the elongate object/objects. The cable insertion section/sections in particular respectively has/have a conic shape tapering towards the sealing section and/or the further sealing sections. Preferably the cable insertion section/sections centers/center the respective elongate object during an insertion procedure.

It is also proposed that the sealing section and/or the further sealing section and/or the cable insertion section/sections respectively have/has a rotationally symmetrical outer surface and/or inner surface. This in particular enables cost-efficient production. The sealing section and/or the further sealing section and/or the cable insertion section/sections in particular respectively have/has a rotation symmetry axis for any desired rotation angles. The sealing section and/or the further sealing section and/or the cable insertion section/sections are/is in particular respectively implemented as hollow bodies/a hollow body. The inner surfaces of the sealing section and/or the further sealing section and of the cable insertion section/sections in particular respectively delimit a hollow space of the sealing unit, which is in particular configured for receiving the elongate object. The hollow space in particular extends along the rotation symmetry axis. In particular, the cable insertion section/sections respectively comprises/comprise one first section, which is embodied in a cylindrical shape, and a second section having a rotationally symmetrical, narrowly tapering shape, for example a truncated-conus shape or a paraboloid-like shape. The shape of the cable insertion section/sections is in particular configured for orienting, and preferably centering, the sealing unit and/or the elongate object within the sealing unit, in particular during an insertion procedure. This in particular allows facilitating a mounting process. Preferentially the cable insertion section/sections and the sealing section and/or the further sealing section are integrally connected with one another. In particular, the cable insertion section/sections and the sealing section and/or the further sealing section are implemented at least partly of a same material.

Furthermore it is proposed that the cable insertion section/sections comprises/comprise respectively at least one soft element and respectively at least one stabilizing element having a greater strength than the soft element. Advantageously the stabilizing elements are implemented identically. This in particular allows enabling an advantageous handling. Advantageously the soft element is implemented of the colloid-like material. In particular, the soft element forms an outer layer of the cable insertion section/sections, in particular defining the outer surface of the cable insertion section/sections. In particular, the stabilizing element/elements respectively at least substantially has/have a rotationally symmetrical, narrowly tapering shape corresponding to the shape of the respective first section and the respective second section of the cable insertion section/sections. Advantageously the stabilizing element/elements respectively forms/form an inner layer of the cable insertion section/sections, in particular defining the inner surface of the cable insertion section/sections. The stabilizing element/elements is/are respectively arranged, in particular completely, within the cable insertion section/sections. The stabilizing element/elements may respectively be made in particular of a thermoplastic synthetic material. Alternatively the stabilizing element/elements may respectively be made of a metallic material or of a composite material. The stabilizing element/elements is/are in particular configured for a stabilization of the cable insertion section/sections against a radial load. Alternatively or additionally it is possible for the stabilizing element/elements to be respectively configured to fixate the elongate object and/or to function as a press wiper, for example for wiping off dirt particles during the insertion procedure of the elongate object.

It is moreover proposed that the stabilizing element/elements respectively has/have at least one first stabilizing section and at least one second stabilizing section which is implemented comb-like. In this way in particular a flexible stabilization is achievable. In particular, the first stabilizing section is implemented in a cylindrical shape. Advantageously the second stabilizing section has a higher flexibility than the first stabilizing section, in particular due to its geometry. In particular, individual teeth of the comb-like second section may bend outwards during the insertion procedure, thus augmenting a diameter of the second stabilizing section. In particular, the respective second stabilizing section of the stabilizing element/elements forms a transition to the sealing section and/or the further sealing sections.

Beyond this it is proposed that the sealing unit is embodied in a one-part implementation. This in particular enables a facilitated assembly procedure. As a result, in particular a construction is achievable that is robust with respect to tension and/or shear loads. In particular, the soft element and the stabilizing element/elements are respectively integrally connected to each other. In particular, the soft element and the stabilizing element/elements are connected with one another in a non-separable fashion. In this way it is in particular possible to facilitate an exchangeability of the sealing unit.

It is also proposed that the sealing unit is produced via a multi-component injection molding procedure, preferably via a two-component injection-molding procedure. This advantageously enables a cost-efficient production. Alternatively the sealing unit may be produced by means of a press procedure. In particular, it is possible for the sealing unit to be produced in one manufacturing step.

Furthermore it is proposed that the sealing unit comprises a connection element for generating a connection of the sealing unit with a sealing panel, wherein the connection element is in particular configured to press the sealing unit to the sealing panel in a connected state. In this way it is in particular possible to create an advantageous sealing between the sealing unit and the sealing panel. In particular, the connection element comprises at least one latch element for establishing a latch connection between the connection element and the sealing panel. Advantageously the latch element comprises a latch lug. In particular due to the establishment of the latch connection, the connection element presses a rim element of the cable insertion section/sections with respect to the sealing panel, which advantageously results in sealing. The connection element is in particular implemented of a material having a higher hardness than the soft element of the sealing unit.

It is further proposed that the connection element is implemented separately from the sealing unit, in particular separately from the stabilizing element/elements. This in particular enables cost-efficient procurement of replacement parts. In particular, a locking of the sealing device within a sealing system, in particular within a cable sleeve, can be enabled, allowing increased reliability. In particular, the connection element can be slid onto the sealing unit and contacts the sealing unit at least substantially in the region of the cable insertion section/sections. In the mounted state of the sealing unit in particular the rim element is subjected by the connection element to a pressure counter to an insertion direction of the elongate element. By an “insertion direction” is in particular a direction to be understood which extends parallel to the pass-through channel, pointing from the cable insertion section/sections to the sealing section and/or the further sealing sections.

Alternatively the connection element may be connected with the sealing unit, in particular in a one-part implementation. This in particular allows achieving a simplification of assembly. Moreover it is in particular possible to reduce a number of structural components. In the mounted state of the sealing unit in particular the rim element is subjected by the connection element with a pressure in the insertion direction of the elongate element. In particular, a cylindrical region of the connection element, together with the cable insertion section/sections of the sealing unit, forms an insertion section for the elongate object. Advantageously integrally is also to mean in a one-part implementation. “In a one-part implementation” is in particular to mean formed in one piece. Preferentially this one piece is produced of a single blank, of a mass and/or of a cast, particularly preferably in an injection-molding process, in particular a one-component and/or multi-component injection-molding process.

It is further proposed that the connection element comprises at least one strain-relief section to provide a strain relief of the object. In this way in particular a disadvantageous tension and/or pressure load on the elongate object is avoidable. In particular, the strain-relief section may fixate the object on the sealing unit via form-fit and/or force-fit connection. Advantageously the strain-relief section comprises at least one clamping element, which is configured to fixate the elongate object, in particular a cable, by means of at least one clamping connection. In particular, the clamping element contacts the elongate object preferably in a circumferential direction. The clamping element is in particular releasable.

In a further implementation it is moreover proposed that the connection element is connected with the stabilizing element/elements. In this way in particular a simple and/or time-saving assembly can be made possible. In addition, in particular a number of structural components is reducible. Advantageously the connection element is respectively integrally connected with the stabilizing element/elements. In particular, the connection element and the stabilizing element/elements are made of a same material, which has a higher hardness than the soft element.

Furthermore a sealing system is proposed, with a sealing device and with at least one sealing panel, in particular a sleeve bottom, comprising at least one receptacle in which the sealing unit is at least partly arrangeable. Advantageously the sealing panel comprises a plurality of receptacles for receiving one sealing unit respectively. In this way in particular an advantageous arrangement and sealing of the sealing unit and the elongate object, advantageously of a plurality of sealing units and of a plurality of elongate objects, are achievable. The receptacles may in particular have different shapes and/or diameters and/or dimensions. In particular, the sealing panel comprises a closure element for each receptacle, wherein the receptacle is closed and in particular sealed by the closure element. The closure element is in particular connected with the sealing panel removably, as a result of which the sealing device is arrangeable in the respective receptacle. In the case of a mounting of the sealing device, in particular the closure element is irreversibly removable by a technician. The receptacle is in particular sealed by the sealing device arranged therein. Further receptacles advantageously remain closed if no sealing devices are arranged in them.

Beyond this the invention is based on a method for sealing at least one elongate object with respect to a sealing panel, with a sealing device with at least one sealing unit by which in a mounted state the object, in particular two objects, is/are at least section-wise completely encompassed in a circumferential direction, and which comprises at least one sealing section and in particular a further sealing section via which, in the mounted state, the object/objects contact each other and is/are sealed via intrinsic pre-tension, in particular of the sealing section and/or the further sealing sections.

It is proposed that the sealing unit is slid onto the object, in particular the objects, and is then connected to a sealing panel, in particular via a connection element. This in particular allows improving and/or simplifying assembly.

The sealing device according to the invention is herein not to be restricted to the application and implementation described above. In particular, for the purpose of fulfilling a functionality described here, the sealing device may comprise a number of individual elements, structural components and units that differs from a number that is mentioned here.

### DRAWINGS

Further advantages will become apparent from the following description of the drawings. In the drawings five exemplary embodiments of the invention are shown. The drawings, the description and the claims contain a plurality of features in combination. Someone skilled in the art will purposefully also consider the features separately and will find further expedient combinations.

It is shown in:

FIG. 1 a portion of a sealing system with a sealing panel that is implemented as a sleeve bottom and with a sealing device, in a mounted state,

FIG. 2 an exploded perspective view of the sealing device,

FIG. 3 a perspective representation of a sealing unit of the sealing device, which is mounted on an elongate object,

FIG. 4 a sectional view of the sealing unit,

FIG. 5 a flow chart of a method for sealing the elongate object,

FIG. 6 an alternative sealing system with a further sealing device,

FIG. 7 an exploded perspective view of the further sealing device of FIG. 6,

FIG. 8 a partial sectional view of the alternative sealing system of FIG. 6,

FIG. 9 an exploded perspective view of a further sealing device,

FIG. 10 an exploded perspective view of a further sealing device,

FIG. 11 a further alternative sealing system with a further alternative sealing device,

FIG. 12 an exploded perspective view of the further alternative sealing device, and

FIG. 13 a perspective sectional view of the further alternative sealing device in a mounted state.

### DESCRIPTION OF THE EXEMPLARY EMBODIMENTS

In the following description there is a variety of structural components and/or units which are manifold present. For simplifying purposes, analogously implemented structural components and/or units are described only once in the following description of the drawings.

In the figures, of manifold present objects respectively only one object is given a reference numeral.

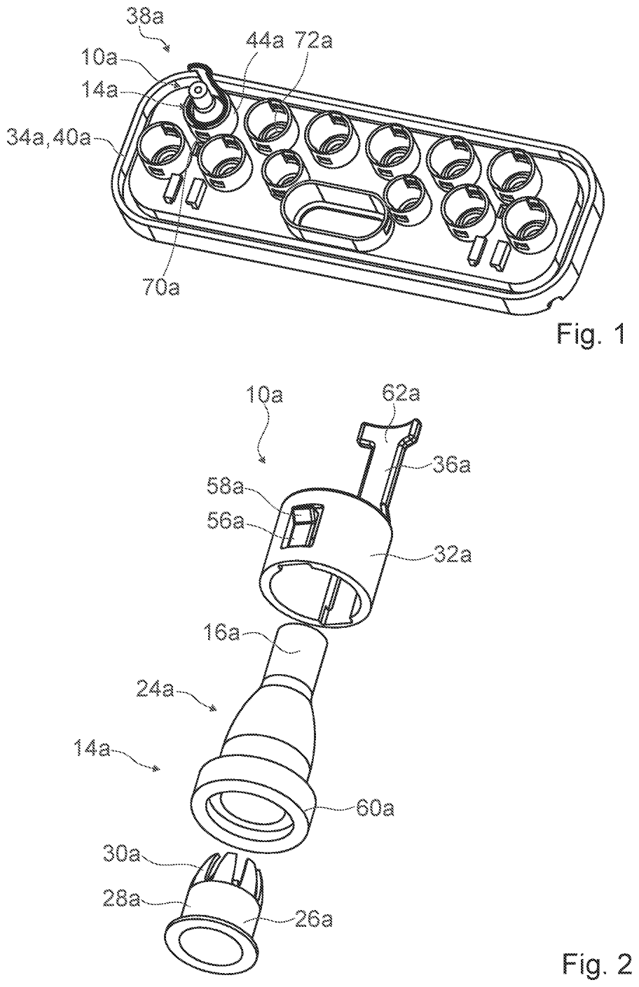

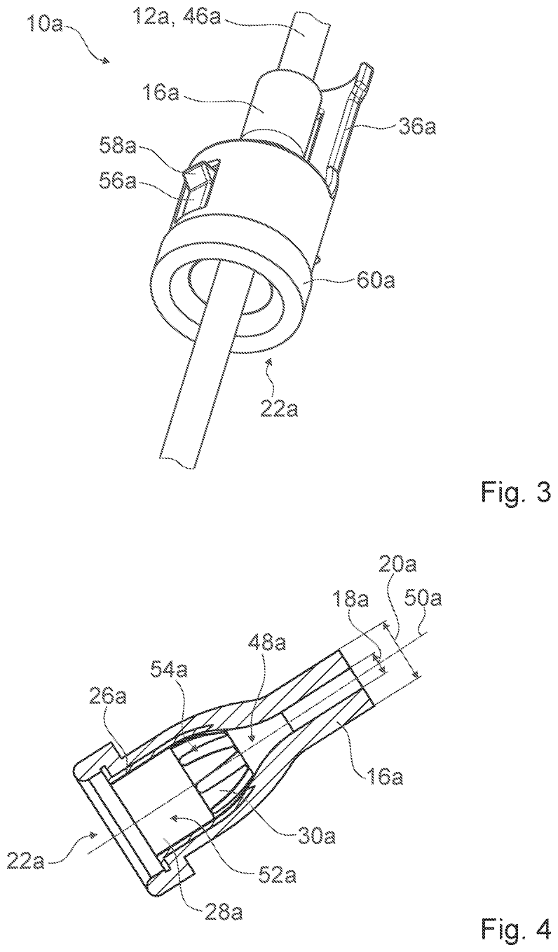

FIG. 1 shows a portion of a sealing system 38a with a sealing device 10a and with a sealing panel 34a. The sealing device 10a is configured for a pass-through and a sealing of an elongate object 12a (see FIG. 3). The object 12a is realized as a cable 46a.

The sealing device 10a comprises a sealing unit 14a (see FIG. 2 and FIG. 3). The sealing unit 14a is implemented in one piece. In a mounted state the sealing unit 14a encompasses the object 12a section-wise completely in a circumferential direction (see FIG. 3).

The sealing panel 34a is implemented as a sleeve bottom 40a with a plurality of receptacles 44a (see FIG. 1). The sealing device 10a is arranged in one of the receptacles 44a. The sealing unit 14a is arranged in one of the receptacles 44a. The receptacles 44a are configured to receive respectively one sealing device 10a. The receptacles 44a may have different shapes. Each receptacle 44a is closed by a respective closure element 72a of the sealing panel 34a. The receptacle 44a is sealed off by the closure element 72a. The closure element 72a is removably connected with the sealing panel 34a. In the case of a mounting of the sealing device 10a, the closure element 72a can be removed irreversibly by a technician. The receptacle 44a with the sealing device 10a that is arranged therein is sealed off by said sealing device 10a. Further receptacles 44a remain closed.

The sealing unit 14a has a rotationally symmetrical outer surface. The sealing unit 14a has a rotationally symmetrical inner surface. The inner surface of the sealing unit 14a delimits a hollow space 48a. The hollow space 48a is configured for receiving the object 12a. The hollow space 48a extends along a rotation symmetry axis 50a (see FIG. 3 and FIG. 4).

The sealing unit 14a comprises a sealing section 16a. The sealing section 16a is implemented in a hollow-cylindrical shape. The sealing section 16a has a rotationally symmetrical outer surface. In a demounted state the sealing section 16a has a constant outer diameter 20a over a large portion of its length. The sealing section 16a has a rotationally symmetrical inner surface. In the demounted state the sealing section 16a has a constant inner diameter 18a at least over a large portion of its length. In a mounted state the sealing section 16a contacts the object 12a. The sealing section 16a seals the object 12a off by an intrinsic pre-tension (see FIG. 3).

The sealing section 16a is implemented of a colloid-like material. The colloid-like material is implemented as a gel. The colloid-like material is implemented as a polyurethane gel.

The sealing unit 14a comprises a cable insertion section 22a. The cable insertion section 22a is configured for an insertion at least of the object 12a. FIG. 4 shows a sectional view of the sealing unit 14a. The cable insertion section 22a is implemented as a hollow body. The cable insertion section 22a has a rotationally symmetrical outer surface. The cable insertion section 22a has a rotationally symmetrical inner surface. In particular, the cable insertion section 22a comprises a first section 52a and a second section 54a. The first section 52a is embodied in a cylindrical shape. The second section 54a has a truncated-cone shape.

The cable insertion section 22a comprises a soft element 24a. The soft element 24a is implemented of the colloid-like material. FIG. 2 shows an exploded perspective view of the sealing device 10a. The cable insertion section 22a comprises a stabilizing element 26a (see FIG. 2 and FIG. 3). The stabilizing element 26a and the soft element 24a are integrally connected with one another. Just for the purpose of a better overview, the stabilizing element 26a and the soft element 24a are depicted separately from one another. The stabilizing element 26a has a higher strength than the soft element 24a. The stabilizing element 26a is arranged completely inside the cable insertion section 22a.

The stabilizing element 26a comprises a first stabilizing section 28a and a second stabilizing section 30a. The first stabilizing section 28a is implemented in a hollow-cylindrical shape. The second stabilizing section 30a is implemented in a comb-like fashion. The second stabilizing section 30a has a narrowly tapering shape. The second stabilizing section 30a is implemented in a truncated-cone shape. Alternatively the second stabilizing section 30 may be implemented in a paraboloid shape.

The sealing unit 14a is produced by a multi-component injection-molding procedure. The cable insertion section 22a and the sealing section 16a are integrally connected with one another. The soft element 24a is part of the cable insertion section 22a and is part of the sealing section 16a. The soft element 24a and the stabilizing element 26a are integrally connected with one another.

The sealing device 10a comprises a connection element 32a (see FIG. 2 and FIG. 4). The connection element 32a is implemented separately from the sealing unit 14a. The connection element 32a is arrangeable on the cable insertion section 22a.

The connection element 32a generates a connection between the sealing unit 14a and the sealing panel 34a. The connection element 32a presses the sealing unit 14a to the sealing panel 34a.

The cable insertion section 22a comprises a rim element 60a. The rim element 60a is arranged on one end of the cable insertion section 22a. In the mounted state the rim element 60a contacts the sealing panel 34a. In the mounted state the connection element 32a presses the rim element 60a to the sealing panel 34a. The connection element 32a creates a sealing between the sealing unit 14a and the sealing panel 34a. The connection element 32a is implemented of a material having a higher hardness than the material of the soft element 24a. The connection element 32a is implemented of a material having a higher hardness than the material of the rim element 60a.

The connection element 32a comprises a first and a second latch element 56a. The latch elements 56a are configured to generate a latch connection between the connection element 32a and the sealing panel 34a. The latch element 56a comprises a latch lug 58a. In the mounted state the latch element 56a engages in an opening 70a on the sealing panel 34a that is complementary to the latch element 56a.

The connection element 32a comprises a strain-relief section 36a. The strain-relief section 36a is configured to provide a strain relief of the object 12a.

The strain-relief section 36a comprises a clamping element 62a. The clamping element 62a fixates the object 12a in a circumferential direction of the object 12a by a clamp connection. For the purpose of generating the clamp connection the clamping element 62a is plastically deformable. The clamp connection is releasable.

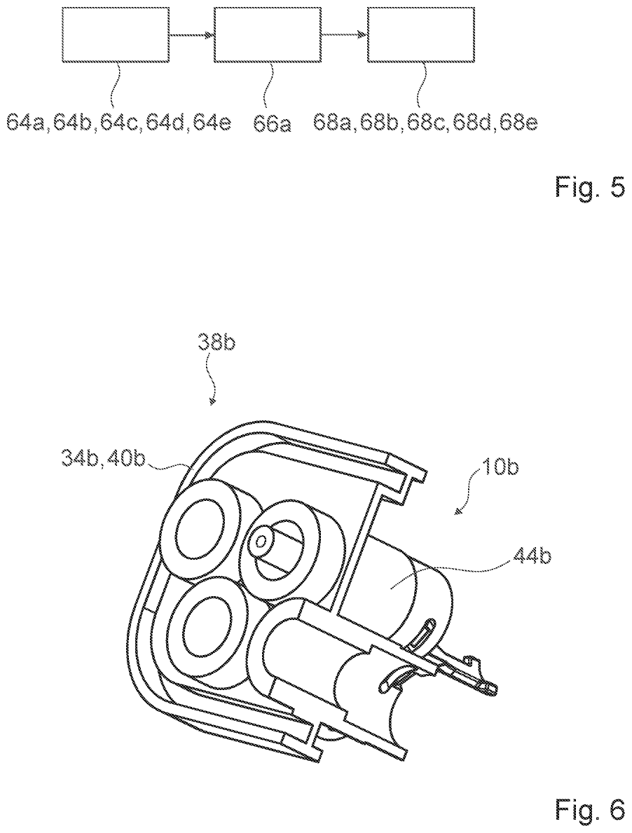

FIG. 5 shows a flow chart of a method for a sealing of the object 12a with respect to the sealing panel 34a, with the sealing device 10a with the sealing unit 14a. In an insertion step 64a the sealing unit 14a is slid onto the object 12a. By an intermediary step 66a the connection element 32a is slid onto the sealing unit 14a and is arranged on the sealing unit 14a by a force-fit and/or form-fit connection. In a latch-in step 68a the sealing unit is connected with the sealing panel 34a via the connection element 32a by means of a latch connection.

FIGS. 6 to 8 show an alternative exemplary embodiment of the sealing system 38b. To avoid unnecessary repetition, the same reference numerals will be used for the same constructional groups, referring to the description of FIGS. 1 to 5. In the following only such details will be considered by which the embodiment of FIGS. 1 to 5 differs from the alternative embodiment of FIGS. 6 to 8. To differentiate between the exemplary embodiments, the letter a added to the reference numerals of the exemplary embodiment of FIGS. 1 to 5 will be substituted by the letter b in the reference numerals of the exemplary embodiment of FIGS. 6 to 8. Regarding identically denominated structural components, in particular regarding structural components having the same reference numerals, principally the drawings and/or the description of the exemplary embodiment of FIGS. 1 to 5 may be referred to.

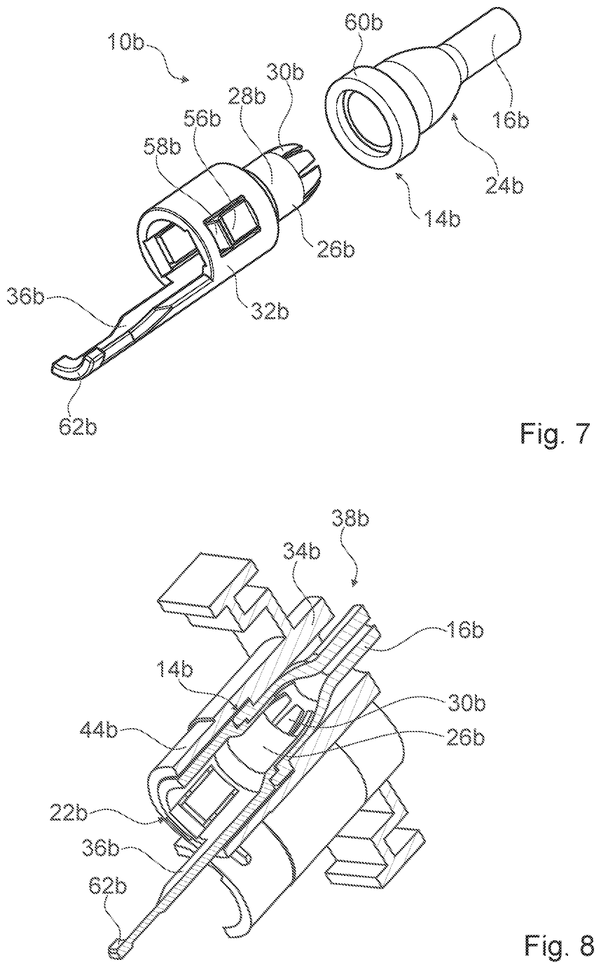

FIG. 6 shows an alternative sealing system 38b with the sealing device 10b. The sealing device 10b comprises the sealing unit 14b and the connection element 32b. The sealing device 10b is arranged in the receptacle 44b of the sealing panel 34b (see FIG. 6 and FIG. 8). FIG. 7 shows an exploded perspective view of the sealing device 10b of the alternative sealing system 38b. The stabilizing element 26b and the soft element 24b are integrally connected with each other. Just for the purpose of a better overview, the stabilizing element 26b and the soft element 24b are depicted separately from each other. The connection element 32b is connected with the stabilizing element 26b in a one-part implementation. The connection element 32b of the alternative sealing system 38b is oriented counter to the connection element 32b. The sealing device 10b is embodied in a one-part implementation. The connection element 32b is arranged on the sealing panel 34b on an outer side of a sleeve bottom 40b.

In a method for a sealing of the object 12b with respect to the sealing panel 34b, with the sealing device 10b with the sealing unit 14b of the alternative sealing system 38b the insertion step 64b and the latch-in step 68b are executed (see FIG. 5). In the method the intermediate step 66a is omitted.

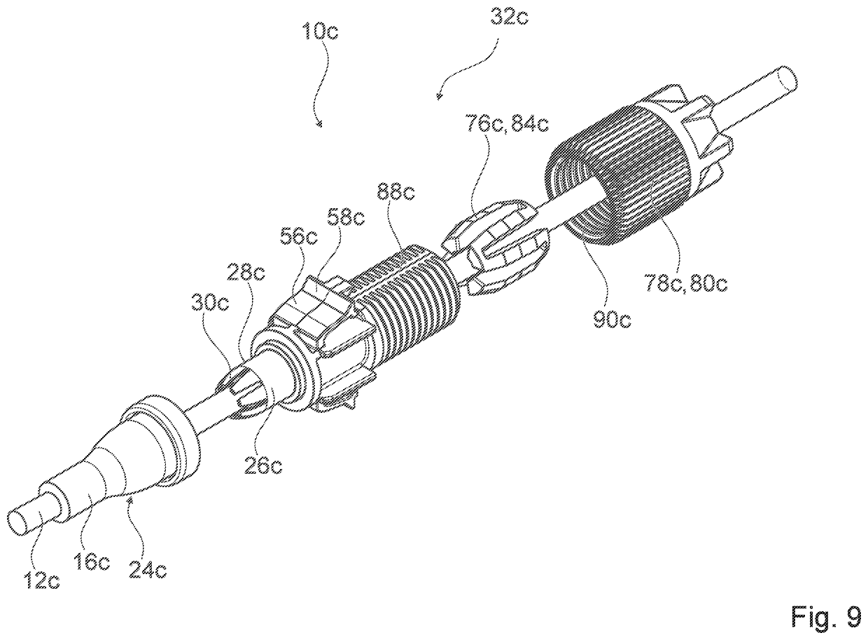

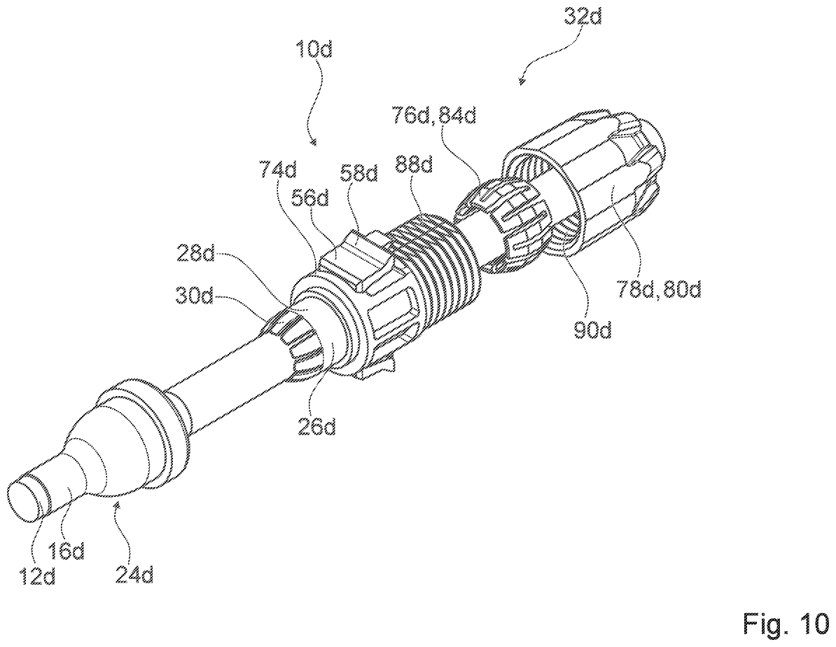

FIGS. 9 and 10 show two further exemplary embodiments of a sealing system 38c, 38d. To avoid unnecessary repetition, the same reference numerals will be used for the same constructional groups and the descriptions of FIGS. 1 to 5 and of FIGS. 6 to 8 are referred to. In the following only such details will be described by which the embodiment of FIGS. 1 to 5 and the embodiment of FIGS. 6 to 8 differ from the further exemplary embodiments of FIGS. 9 and 10. To differentiate between the exemplary embodiments, the letter a added to the reference numerals of the exemplary embodiment illustrated in FIGS. 1 to 5 and the letter b added to the reference numerals of the exemplary embodiment illustrated in FIGS. 6 to 8 has been substituted by the letter c in the reference numerals of the exemplary embodiment of FIG. 9 and by the letter d in the reference numerals of the exemplary embodiment of FIG. 10. Regarding identically denominated structural components, in particular regarding structural components having the same reference numerals, principally the drawings and/or descriptions of the exemplary embodiments of FIGS. 1 to 8 may be referred to.

FIG. 9 shows an alternative sealing device 10c in an exploded perspective view with an elongate object 12c. The sealing device 10c is arrangeable in a receptacle 44c of a sealing panel 34c. A stabilizing element 26c and a soft element 24c are integrally connected with each other. Just for the purpose of a better overview, the stabilizing element 26c and the soft element 24c are depicted separately from each other.

A strain-relief section 36c is embodied in a multi-part implementation. The strain-relief section 36c is embodied in a three-part implementation.

The strain-relief section 36c comprises a connecting section 74c for generating a connection between a connection element 32c and the sealing panel 34c.

The strain-relief section 36c comprises a strain-relief element 76c for directly contacting an elongate object 12c. The strain-relief element 76c is implemented as a tension-cable-like lamellate insert 84c.

The strain-relief section 36c comprises a pressure-applying element 78c. The pressure-applying element 78c is embodied as an acorn nut 80c. The strain-relief element 76c and the pressure-applying element 78c each have a pass-through region for a pass-through of the elongate object 12c. The strain-relief element 76c and the pressure-applying element 78c are arranged on the elongate object 12c.

The connecting section 74c is connected with the stabilizing element 26c in a one-part implementation. The connecting section 74c is arranged on the sealing panel 34c on an outer side of a sleeve bottom 40c.

The connecting section 74c comprises a first and a second latch element 56c. The latch elements 56c are configured to generate a latch connection between the connecting section 74c and the sealing panel 34c. The latch element 56c comprises a latch lug 58c. In the mounted state the latch element 56c engages into an opening 70c on the sealing panel 34c that is complementary to the latch element 56c.

The connecting section 74c has an external thread 88c. The pressure-applying element 78c has an internal thread 90c that is complementary to the external thread 88c of the connecting section 74c.

In a mounted state the strain-relief element 76c is arranged between the connecting section 74c and the pressure-applying element 78c. In the mounted state the pressure-applying element 78c is connected with the connecting section 74c via a force-fit connection between the external thread 88c and an internal thread 90c. In the mounted state the pressure-applying element 78c exerts a pressure onto the strain-relief element 76c. In the mounted state the pressure-applying element 78c presses the strain-relief element 76c into and/or against the connecting section 74c, thus decreasing the pass-through region of the strain-relief element 76c. In the mounted state the pressure exerted by the pressure-applying element 78c is transferred to the elongate object 12c. In the mounted state a slip-resistance is created between the strain-relief element 76c and the elongate object 12c in a circumferential direction. In the mounted state a force-fit connection is created between the strain-relief element 76c and the elongate object 12c in the circumferential direction.

In FIG. 10 an exploded perspective view of a further sealing device 10d is shown. The exemplary embodiment of the sealing device 10d differs from the exemplary embodiment of the sealing device 10c only in that the sealing device 10d is configured for a pass-through and sealing of an elongate object 12d having a greater diameter in comparison to a diameter of the elongate object 12c. Regarding identically denominated structural components, in particular regarding structural components having the same reference numerals, principally the drawings and/or the description of the exemplary embodiments of FIGS. 1 to 8 and of FIG. 9 may be referred to.

In a method for a sealing of the elongate object 12c, 12d with respect to the sealing panel 34c, 34d, with the sealing device 10c, 10d with the sealing unit 14c, 14d, the insertion step 64c, 64d and the latch-in step 68c, 68d are executed (see FIG. 5). In the method the intermediate step 66a is omitted.

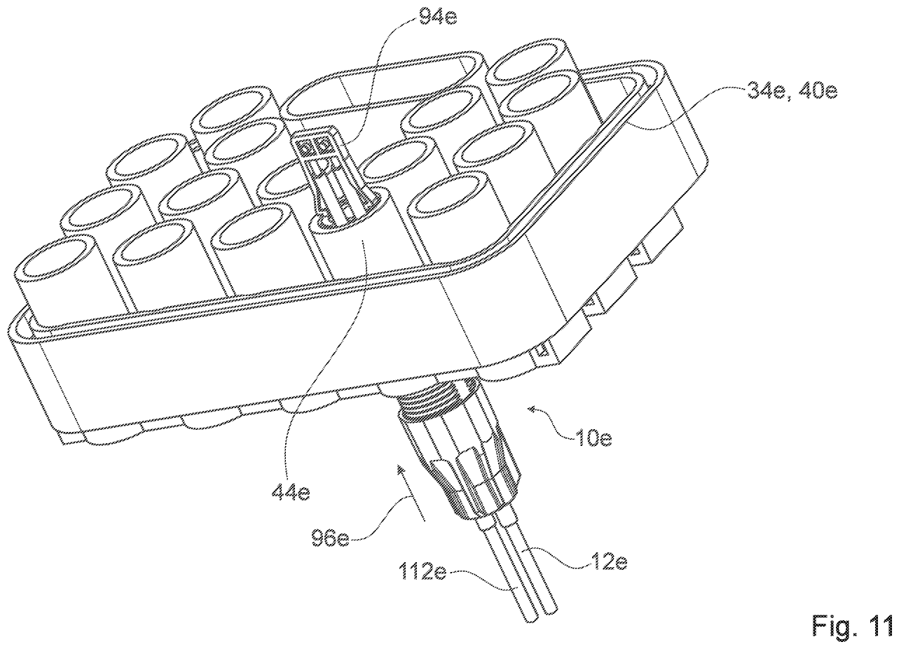

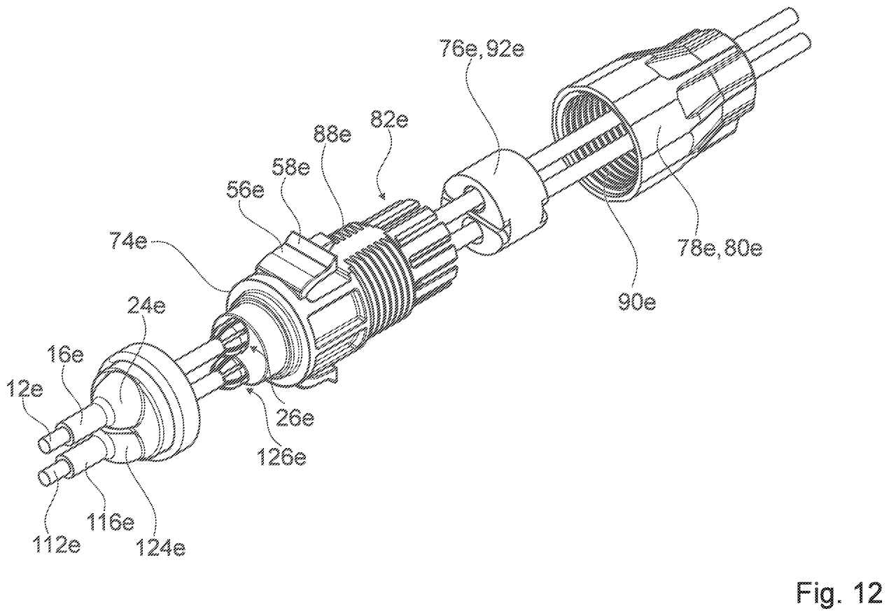

FIG. 11 shows a further alternative sealing system 38e with a further alternative sealing device 10e. To avoid unnecessary repetition, the same reference numerals are used for the same constructional groups, and the explanations of FIGS. 1 to 8 and of FIGS. 9 and 10 are referred to. In the following only such details will be considered by which the embodiments of FIGS. 1 to 8 and of FIGS. 9 and 10 differ from the embodiment of FIGS. 11 and 12. For differentiating between the exemplary embodiments, the letters a-d added to the reference numerals in FIGS. 1 to 10 are substituted by the letter e in the reference numerals of the exemplary embodiment of FIGS. 11 and 12. Regarding identically denominated structural components, in particular regarding structural components having the same reference numerals, principally the drawings and/or the description of the exemplary embodiments of FIGS. 1 to 10 may be referred to.

The sealing device 10e is arranged in one of receptacles 44e of a sealing panel 34e. On a side of the sealing panel 34e opposing a mounting direction 96e of the sealing device 10e, a strain-relief unit 94e of a sealing system 38e is arranged at the receptacle 44e. The strain-relief unit 94e is configured for receiving and fastening at least one central element of an elongate object 12e and/or of a further elongate object 112e.

FIG. 12 shows an exploded perspective view of the sealing device 10e. A sealing unit 14e comprises a sealing section 16e. The sealing unit 14e comprises a further sealing section 116e. The further sealing section 116e and the sealing section 16e are implemented identically.

In the mounted state the further sealing section 116e contacts a further elongate object 112e that is different from the elongate object 12e. The further sealing section 116e seals the further elongate object 112e off by intrinsic pre-tension. The further elongate object 112e and the elongate object 12e are implemented identically.

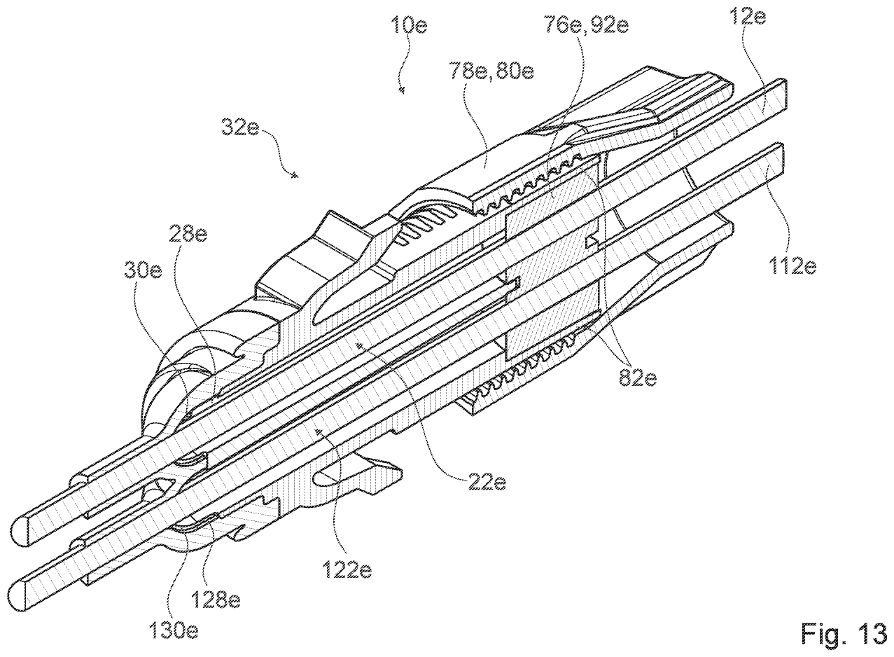

The sealing unit 14e comprises two cable insertion sections 22e, 122e (see FIG. 13). The cable insertion sections 22e, 122e have respectively one stabilizing element 26e, 126e (see FIG. 13). The cable insertion section 22e is configured for an insertion of the elongate object 12e. The cable insertion section 122e is configured for an insertion of the further elongate object 112e.

The stabilizing elements 26e, 126e are implemented identically. The stabilizing elements 26e, 126e have respectively one first stabilizing section 28e, 128e and one second stabilizing section 30e, 130e.

A connection element 32e is integrally connected with the stabilizing elements 26e, 126e. Soft elements 24e, 124e of the stabilizing elements 26e, 126e are embodied in a one-part implementation. The soft elements 24e, 124e and the stabilizing elements 26e, 126e are integrally connected with one another. The soft elements 24e, 124e and the stabilizing elements 26e, 126e are inseparably connected with one another.

A strain-relief section 36e is embodied in a multi-part implementation. The strain-relief section 36e is embodied in a three-part implementation. The strain-relief section 36e comprises a connecting section 74e for generating a connection between the connection element 32e and the sealing panel 34e. The connecting section 74e has at its end lamellae which are arranged in a circumferential direction in the shape of a lamellae cage 82e.

The strain-relief section 36e comprises a strain-relief element 76e for directly contacting an elongate object 12e. The strain-relief element 76e is embodied as a flexible element 92e. The flexible element 92e may be implemented of rubber, of neoprene and/or of a thermoplastic material. The strain-relief element 76e comprises two pass-through regions for a pass-through of the elongate object 12e and the further elongate object 112e.

The strain-relief section 36e comprises a pressure-applying element 78e. The pressure-applying element 78e is embodied as an acorn nut 80e. The strain-relief element 76e and the pressure-applying element 78e are arranged on the elongate object 12e and the further elongate object 112e.

The connecting section 74e is connected with the stabilizing elements 26e, 126e in a one-part implementation. The connecting section 74e is arranged on the sealing panel 34e on an outer side of the sleeve bottom 40e.

The connecting section 74e comprises a first and a second latch element 56e. The latch elements 56e are configured for generating a latch connection between the connecting section 74e and the sealing panel 34e. The latch element 56e comprises a latch lug 58e. In the mounted state the latch element 56e engages into an opening 70e on the sealing panel 34e that is complementary to the latch element 56e.

The connecting section 74e comprises an external thread 88e. The pressure-applying element 78e comprises an internal thread 90e that is complementary to the external thread 88e of the connecting section 74e. The strain-relief element 76e is in a mounted state arranged between the connecting section 74e and the pressure-applying element 78e. In the mounted state the pressure-applying element 78e is connected with the connecting section 74e via a force-fit connection between the external thread 88e and the internal thread 90e. In the mounted state the strain-relief element 76e is at least partially arranged within the lamellae cage 82e. In the mounted state the pressure-applying element 78e exerts a pressure onto the lamellae of the lamellae cage 82e. In the mounted state the lamellae exert a pressure onto the strain-relief element 76e. The pressure-applying element 78e presses the strain-relief element 76e into the connecting section 74e. In the mounted state the pressure-applying element 78e constricts the pass-through regions of the strain-relief element 76e.

In the mounted state the pressure exerted onto the lamellae cage 82e and thus onto the strain-relief element 76e by the pressure-applying element 78e is transferred to the elongate object 12e and the further elongate object 112e. In the mounted state a slip-resistance is created between the strain-relief element 76e and the elongate object 12e and the further elongate object 112e in a circumferential direction. In the mounted state a force-fit connection is generated between the strain-relief element 76e and the elongate object 12e and the further elongate object 112e in the circumferential direction.

FIG. 5 shows a flow chart of a method for a sealing of the object 12a with respect to the sealing panel 34a, with the sealing device 10a with the sealing unit 14a. In an insertion step 64a the sealing unit 14a is slid onto the object 12a. By an intermediate step 66a the connection element 32a is slid onto the sealing unit 14a and is arranged on the sealing unit 14a via a force-fit and/or form-fit connection. In a latch-in step 68a the sealing unit 14a is connected with the sealing panel 34a by the connection element 32a via a latch connection.

In a method for a sealing of the elongate object 12e and the further elongate object 112e with respect to the sealing panel 34e, with the sealing device 10e with the sealing unit 14e, the insertion step 64e and the latch-in step 68e are executed (see FIG. 5). In the method an intermediate step 66a is omitted.

### REFERENCE NUMERALS

10 sealing device
12 elongate object
14 sealing unit
16 sealing section
18 inner diameter
20 outer diameter
22 cable insertion section
24 soft element
26 stabilizing element
28 first stabilizing section
30 second stabilizing section
32 connection element
34 sealing panel
36 strain-relief section
38 sealing system
40 sleeve bottom
44 receptacle
46 cable
48 hollow space
50 rotation symmetry axis
52 first section
54 second section
56 latch element
58 latch tab
60 rim element
62 clamping element
64 insertion step
66 intermediate step
68 latch-in step
70 opening
72 closure element
74 connecting section
76 strain-relief element
78 pressure-applying element
80 acorn nut
82 lamellae cage
84 lamellate insert
88 external thread
90 internal thread
92 flexible element
94 strain-relief unit
96 mounting direction
112 further elongate object
116 further sealing section
122 cable insertion section
124 soft element
126 stabilizing element
128 first stabilizing step
130 second stabilizing step

1. A sealing device for a pass-through and sealing of an elongate object, with at least one sealing unit which is configured, in a mounted state, to encompass the object at least section-wise completely in a circumferential direction, and which comprises at least one sealing section that is configured, in the mounted state, to contact the object and to seal it by means of intrinsic pre-tension, wherein the sealing section is implemented at least partially of a colloid-like material.

2. The sealing device according to claim 1, wherein the sealing unit comprises at least one further sealing section, which is configured, in the mounted state, to contact and to seal by intrinsic pre-tension at least one further elongate object that differs from the elongate object.

3. The sealing device according to claim 1, wherein in at least one demounted state the sealing section (116e) has an at least substantially constant respective inner diameter at least over a large portion of its length.

4. The sealing device according to claim 1, wherein in at least one demounted state the sealing section has an at least substantially constant respective outer diameter at least over a large portion of its length.

5. The sealing device according to claim 1, wherein the sealing unit comprises at least one cable insertion section for an insertion of the object and/or of the further object.

6. The sealing device according to claim 1, wherein the sealing section has a rotationally symmetrical outer surface and/or inner surface.

7. The sealing device according to claim 5, wherein the cable insertion section comprises at least one soft element and at least one stabilizing element having a greater strength than the soft element.

8. The sealing device according to claim 7, wherein the stabilizing element has at least one first stabilizing section and has at least one second stabilizing section which is implemented comb-like.

9. The sealing device according to claim 1, wherein the sealing unit is embodied in a one-part implementation.

10. The sealing device according to claim 9, wherein the sealing unit is produced via a multi-component injection-molding procedure.

11. The sealing device according to claim 1, further comprising a connection element for generating a connection of the sealing unit with a sealing panel, wherein the connection element is configured to press the sealing unit to the sealing panel in a connected state.

12. The sealing device according to claim 11, wherein the connection element is implemented separately from the sealing unit.

13. The sealing device according to claim 11, wherein the connection element comprises atleast one strain-relief section a strain relief of the object and/or of the further object.

14. The sealing device according to claim 11, wherein the cable insertion section comprises at least one soft element and at least one stabilizing element having a greater strength than the soft element, wherein the connection element is connected with the stabilizing element.

15. A sealing system with a sealing device according to claim 1 and with at least one sealing panel comprising at least one receptacle in which the sealing unit is at least partly arrangeable.

16. A method for sealing at least one elongate object with respect to a sealing panel, with a scaling device, in particular according to claim 1, with at least one sealing unit by which in a mounted state the object is at least section-wise completely encompassed in a circumferential direction, and which comprises at least one scaling section via which, in the mounted state, the object is contacted and is scaled via intrinsic pre-tension, wherein the sealing unit is slid onto the object and is then connected to a sealing panel.
